(19) United States
(12) Patent Application Publication
(10) Pub. No.: US 2014/0351193 A1
(43) Pub. Date: Nov. 27, 2014

(54) METHOD AND DEVICE FOR POST-ADAPTION OF A DATA-BASED FUNCTION MODEL

(71) Applicants: Tobias LANG, Kirchberg (DE); Heiner MARKERT, Stuttgart (DE); Michael HANSELMANN, Korntal (DE)

(72) Inventors: Tobias LANG, Kirchberg (DE); Heiner MARKERT, Stuttgart (DE); Michael HANSELMANN, Korntal (DE)

(73) Assignee: ROBERT BOSCH GMBH, Stuttgart (DE)

(21) Appl. No.: 14/286,030

(22) Filed: May 23, 2014

(30) Foreign Application Priority Data
May 27, 2013 (DE) 10 2013 209 851.0

(51) Int. Cl. G06N 5/02

(52) U.S. Cl. CPC G06N 5/022
USPC 706/46

(57) ABSTRACT

A method for post-adaption of an at least partially data-based function model which corresponds to a sum of a basis function model, e.g., a data-based basis function model, and an additive fault model, includes: providing the basis function model; recording training data; ascertaining the data-based additive fault model based on difference training data which represent differences between the measured values of the training data and the function values of the data-based basis function model at the measuring points of the training data;

and modifying the training data and/or the additive fault model so that function values of the data-based function model remain within a predefined adaption range.

### BACKGROUND OF THE INVENTION

1. Field of the Invention

The present invention relates to control units in which control path and system functions are mapped with the aid of data-based function models, and also relates to a post-adaption of data-based function models.

2. Description of the Related Art

Control units for controlling engine systems having internal combustion engines include a plurality of control path and system models to carry out control and regulating functions and modelings of physical units and/or system variables in the internal combustion engine. The use of a model calculation unit which makes calculating functions, implemented in hardware, available for calculating data-based function models, in particular for calculating Gaussian process models, allows the implementation of data-based function models for real-time calculations in a control unit for an internal combustion engine.

In general, the data-based function models are created with the aid of training data, and model data are generated which describe the function model. In function models which are based on a Bayesian regression, hyperparameters and node data may be generated as model data for defining the data-based function models, these hyperparameters and node data being stored in the control unit and being available for calculating the data-based function models.

A subsequent modification of the data-based function models which are stored in the control unit is generally only possible by a post-adaption, which typically cannot be carried out online due to the limited calculating capacity in the control unit. However, an online adaption is necessary to compensate for propagation time-induced drift of component parameters and to compensate for new part tolerances and the like.

### BRIEF SUMMARY OF THE INVENTION

According to the present invention, a method is provided for post-adaption of an at least partially data-based function model which corresponds to a sum of a basis function model and a data-based additive fault model. The method includes the following steps:
providing hyperparameters and node data for the definition of a data-based basis function model;
recording training data;
ascertaining the additive fault model based on difference training data which represent differences between the measured values of the training data and the function values of the basis function model at the measuring points of the training data; and
modifying the training data and/or the additive fault model so that function values of the function model remain within a predefined adaption range.

An important aspect in the adaption of function models is that it must be ensured that function values of post-adapted function models do not deviate too far from the predefined functions which were parameterized by an application engineer (e.g., the specifications by the training data) since this may be problematic, in particular with safety-relevant functions, and since large deviations are rather indicative of a component fault than of tolerances or parameter fluctuations.

One idea of the above-mentioned method for post-adaption of a data-based function model is to limit the deviations of the post-adapted data-based function model from the formerly existing model, or the basis function model, during the post-adaption to rule out that the data-based function model is modified so much that the desired function of the physical system to be controlled, such as the function of the internal combustion engine, is no longer ensured or that safety-critical operating ranges are assumed.

A post-adaption of a basis function model may be carried out by applying an additive fault model to a basis function model, the additive fault model describing only the deviation of the post-adapted function model from the data-based basis function model. The additive fault model is initially parameterized in such a way that the output for the entire value range is constantly zero. The basis function model which is made available is not modified by the post-adaption. In the case of subsequently recorded training data, it is thus possible to create an additive fault model for the deviations of the training data points from the function values of the basis function model, so that the function model which is implemented in the control unit is able to ascertain the function value as a sum of the function values of the basis function model and of the data-based additive fault model.

To prevent the function values of the post-adapted function model from deviating significantly from the function value of the basis function model as a result of the post-adaption, a limitation of the function values of the post-adapted function model is provided for. It is thus possible to limit the effects of the post-adaption to predefined limiting values, whereby a safety-critical deviation from the function of the basis function model, and thus damage to the system and/or injury to persons, are preventable.

Moreover, the measured values of the training data may be modified by limitation to a predefined upper or lower limiting value, in particular one which is predefined in absolute or relative terms.

In particular, the upper or lower limiting value may depend on the measuring point assigned to the corresponding measured value. In particular, the limiting values are also predefinable by a limiting model which, e.g., is based on the variance of the training data.

According to one specific embodiment, a limiting function may be applied to the additive fault model before it is added to the data-based basis function model.

It may be provided that the application of the limiting function causes the maximal function value of the additive fault model and the minimal function value of the additive fault model to form the upper and lower limiting values of the adaption range.

The limiting function may correspond to a sigmoid function, in particular a Fermi function, or to a smoothstep or smootherstep function.

It may be provided that the limiting function corresponds to a linear function having a slope of 1 within an adaption exclusion range situated within the adaption range.

According to one specific embodiment, the basis function model may be at least partially designed as a data-based basis function model, in particular as a Gaussian process model, which is defined by predefined hyperparameters and node data.

According to one further aspect, a device, in particular an arithmetic unit, is provided for the post-adaption of an at least partially data-based function model which includes a sum of a basis function model, in particular a data-based basis function model, and an additive fault model. The device is designed to:
provide hyperparameters and node data for the definition of a data-based basis function model;
record training data;
ascertain the data-based additive fault model based on difference training data which represent differences between the measured values of the training data and the function values of the basis function model at the measuring points of the training data; and
modify the training data and/or the additive fault model in such a way that function values of the function model remain within a predefined adaption range.

According to one further aspect, a computer program is provided which is designed to carry out all steps of the above-mentioned method.

### BRIEF DESCRIPTION OF THE DRAWINGS

FIG. 1 shows a schematic illustration of a control unit for controlling an internal combustion engine in an engine system.

FIG. 2 shows a flow chart to illustrate a method for post-adaption of a data-based basis function model.

FIG. 3 shows a diagram to illustrate a globally constant limitation of a function value of a post-adapted data-based function model.

FIG. 4 shows an illustration of a curve of a Fermi function.

FIG. 5 shows a diagram to illustrate a curve of a post-adapted data-based function model, the curve being limited by a Fermi function.

FIG. 6 shows a diagram to illustrate the curves of upper and lower limiting values of an exemplary adaption range and an adaption exclusion range.

FIG. 7 shows an illustration of a curve of a smoothstep function.

FIG. 8 shows an illustration of the curve of function values of a post-adapted data-based function model which are limited to predefined limiting values with the aid of a smoothstep function.

### DETAILED DESCRIPTION OF THE INVENTION

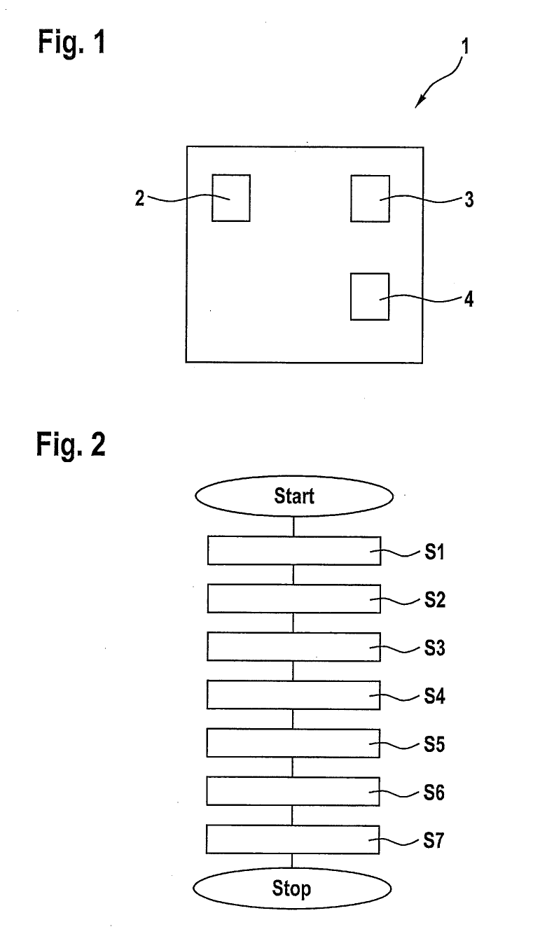

FIG. 1 shows a schematic illustration of the design of a control unit 1, in particular for controlling a physical system, such as an internal combustion engine in a motor vehicle. Control unit 1 includes a microcontroller as arithmetic unit 2, which is implemented together with a model calculating unit 3 in integrated form. Model calculating unit 3 is essentially a hardware unit, which is able to carry out function calculations based on a Bayesian regression method using hardware. Model calculating unit 3 is suitable in particular for calculating Gaussian process models.

Calculations in model calculating unit 3 are started by arithmetic unit 2 to ascertain a function value for a test point based on hyperparameters and node data describing the model. The hyperparameters and node data are stored in a memory unit 4, which is additionally integrated with control unit 1 and model calculating unit 3, and are used to represent a basis function model describing the operation of the physical system.

During the operation of control unit 1, measured values are recorded by a variety of functions in the engine system of the motor vehicle and are stored as further training data, e.g., in memory unit 4. The further training data are used to subsequently carry out an adaption of the data-based basis function model which is implemented in control unit 1 based on the hyperparameters and node data.

In conjunction with the flow chart of FIG. 2, one procedure for post-adaption of a data-based basis function model is described hereafter in detail.

Proceeding from step S1, in which node data and hyperparameters are provided in a control unit 1 for the definition of a data-based basis function model which is based on a Gaussian process model, in step S2 further measured values are recorded at measuring points during the ongoing operation of control unit 1 or of the engine system of the motor vehicle, the further measured values forming the training data for a post-adaption.

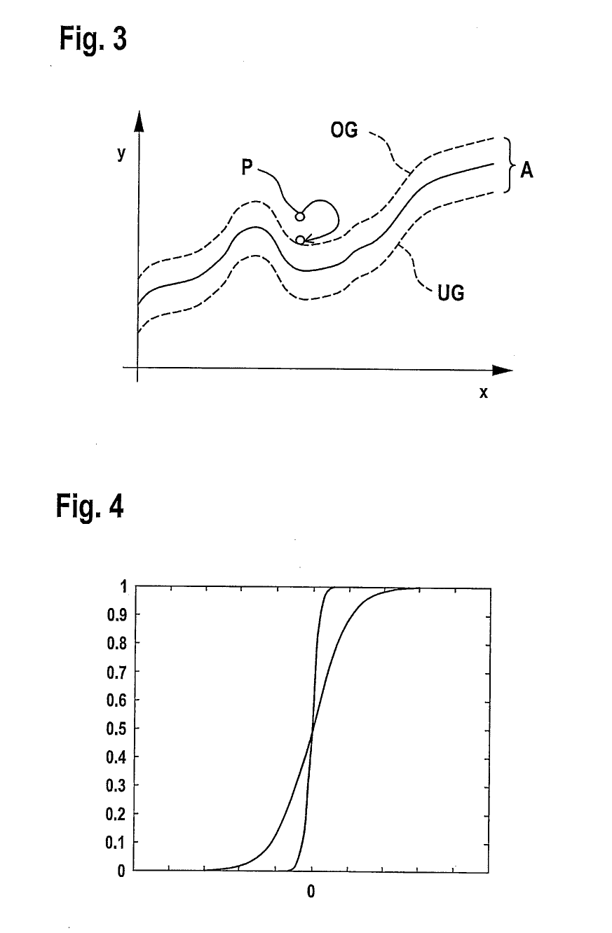

In step S3, the measured values of the training data are initially limitable, so that the deviation at a measuring point x from the corresponding function value y of the data-based basis function model is within predefined limits. Such a limitation is illustrated in FIG. 3 based on the curves of upper limiting values OG and lower limiting values UG for a data-based model, which by way of example is one-dimensional, the curves of the upper limiting values OG and of the lower limiting values UG surrounding the curve of the function values of the assumed basis function model. It is apparent that a measured value P at a measuring point x of the further training data, which is situated outside an adaption range A defined by the curves of upper limiting values OG and lower limiting values UG, is modified to the corresponding closest limitation of adaption range A.

For example, if measured value y is situated outside adaption range A at a measuring point x, measured value y may be set to the maximal possible deviation from the function value of the data-based basis function model as determined by the curves of upper limiting values OG and lower limiting values UG, or the measured value may be modified to a value within adaption range A. As an alternative, measuring point x in question of the further training data may also be ignored or even deleted for subsequent adaptions.

A manipulation of the further training data is thus optional, and it may likewise be provided to carry out the adherence to adaption range A by post-adaption after the modeling of the additive fault model.

Based on the optionally modified training data from step S3, an additive fault model is created in step S4. For this purpose, a difference between the measured values of the training data and the corresponding function value of the data-based basis function model at measuring point x is ascertained for each measuring point x of the training data in step S4 to obtain difference training data.

Based on the difference training data, in step S5 now an additive fault model is ascertained, in a manner known per se, using optimization methods which are customary for data-based function models.

In general, the use of nonparametric, data-based function models is based on a Bayesian regression method. The Bayesian regression is a data-based method using a model as the basis. Measuring points of training data as well as associated output data of an output variable are required to create the model. The model is created by using node data which entirely or partially correspond to the training data or which are generated from these. Moreover, abstract hyperparameters are determined, which parameterize the space of the model functions and effectively weight the influence of the individual measuring points of the training data on the later model prediction.

The abstract hyperparameters are determined by an optimization method. One option for such an optimization method is an optimization of a marginal likelihood p(Y|H,X). The marginal likelihood p(Y|H,X) describes the plausibility of the measured y values of the training data, represented as vector Y, with specification of model parameters H and the x values of the training data. In the model training, p(Y|H,X) is maximized by finding suitable hyperparameters with which the data may be described particularly well. To simplify the calculation, the logarithm of p(Y|H,X) is maximized.

The optimization method automatically ensures a trade-off between model complexity and mapping accuracy of the model. While an arbitrarily high mapping accuracy of the training data is achievable with rising model complexity, this may result in overfitting of the model to the training data at the same time, and thus in a worse generalization property.

The result of the creation of the nonparametric, data-based function model that is obtained is:

$$v = {\sum }_{i = 1}^{N} {( {Q}_{y} )}_{i} {σ}_{f} exp ( - \frac{1}{2} {\sum }_{d = 1}^{D} \frac{{( {( {x}_{i} )}_{d} - {u}_{d} )}^{2}}{{l}_{d}} )$$

where v corresponds to the standardized model value at a standardized test point u, xᵢ corresponds to a measuring point of the training data, N corresponds to the number of measuring points of the training data, D corresponds to the dimension of the input data/training data space, and I_{d} and σ_{f} correspond to the hyperparameters from the model training. Q_{y} is a variable calculated from the hyperparameters and the measuring data.

In step S6, the data-based overall function model is ascertained from the sum of the data-based basis function model and the additive fault model.

In a subsequent step S7, the function values of the data-based overall function model are limited to ensure that the function value is within the predefined adaption range A. The predefined adaption range A may be defined as a global constant limitation around the function value curve determined by the data-based basis function model, such as by specification of a maximal absolute deviation, e.g., by specification of the curves of upper limiting values OG and lower limiting values UG. For example, it may be specified that the maximal deviation of the function value of the resulting post-adapted data-based function model from the data-based basis function model may not amount to more than a predefined absolute value. For example, this predefined value may be derived from the known variance of a particular component which is relevant for the basis function model.

Locally variable upper and lower limiting values OG, UG are also conceivable for the varying limitation of adaption range A. For example, a functional dependency of the threshold values, which determine the upper and lower limits of adaption range A, on the considered measuring point may be predefined, for example, in the form of an absolute or relative deviation which is dependent on the input variables of the basis function model. The functional dependency of the threshold values for adaption range A need not be continuous, and it may also be provided that local larger or smaller deviations are allowed, depending on the operating range. If the function value ascertained by the post-adapted data-based function model is outside an adaption range A thus predefined, the corresponding function value of the post-adapted data-based function model may be limited to the maximal or minimal value of adaption range A.

To prevent the post-adapted data-based function model from being given kinks as a result of the limitation, and potentially not being derivable as a result, it may be provided that the limitation is carried out with the aid of a sigmoid function. For this purpose, the function value of the post-adapted data-based function model is limited with the aid of a Fermi function, for example,

$$f ( y ) = \frac{1}{1 + {e}^{- ky}}$$

where k defines the steepness of the function in its center area and is selected in such a way that the slope in the center area is 1. The curve of the Fermi function is shown in FIG. 4.

The Fermi function maps the function value of the post-adapted data-based function model, a limitation to adaption range A being achieved in the area close to the upper or lower limit of adaption range A.

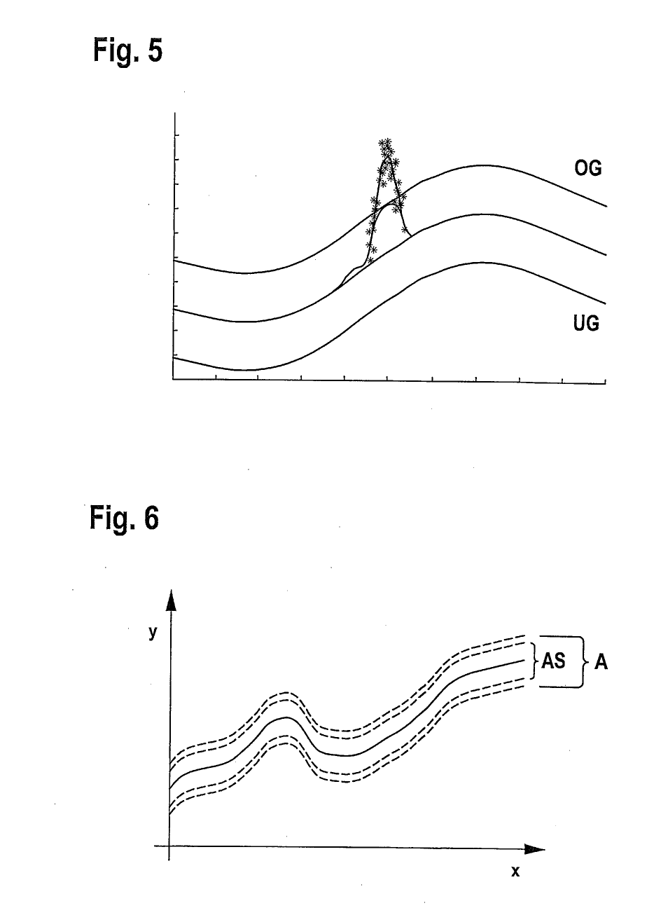

To carry out the adaption, it may be provided that, prior to the addition of the additive fault model to the data-based basis function model, in step S6 the Fermi function is applied to the additive fault model, and only then is the additive fault model to which the Fermi function has been applied added to the data-based basis function model. A function curve which is limited to adaption range A, as it is shown in FIG. 5, is obtained as the curve of the function values of the post-adapted data-based function model to which a Fermi function has been applied.

The function thus generated is differentiable; however, an improper selection of constant k may cause the further training data, whose starting value is clearly within adaption range A, to also no longer be approximatable well. Preferred values for constant k are between 2 and 6, preferably k=4.

As an alternative, it may be useful, as is shown in the function curve diagram of FIG. 6, to introduce an additional adaption exclusion range AS, e.g., with the aid of a specification of a further upper and lower limiting value OG′, UG′ within adaption range A, to carry out the transformation with the aid of the above-mentioned Fermi function only for starting values of the additive fault model outside the adaption exclusion range. It would be conceivable to provide the further upper or lower threshold value in a range of ±70% of upper and lower limiting values OG, UG defining adaption range A.

Instead of masking out the Fermi function within the adaption exclusion range, it is also possible to employ a linear function there.

Instead of the Fermi function, a smoothstep function may also be used. The smoothstep function is defined at the interval [0;1] and may be written as:

f(y)=y*Y*(3−2*y).

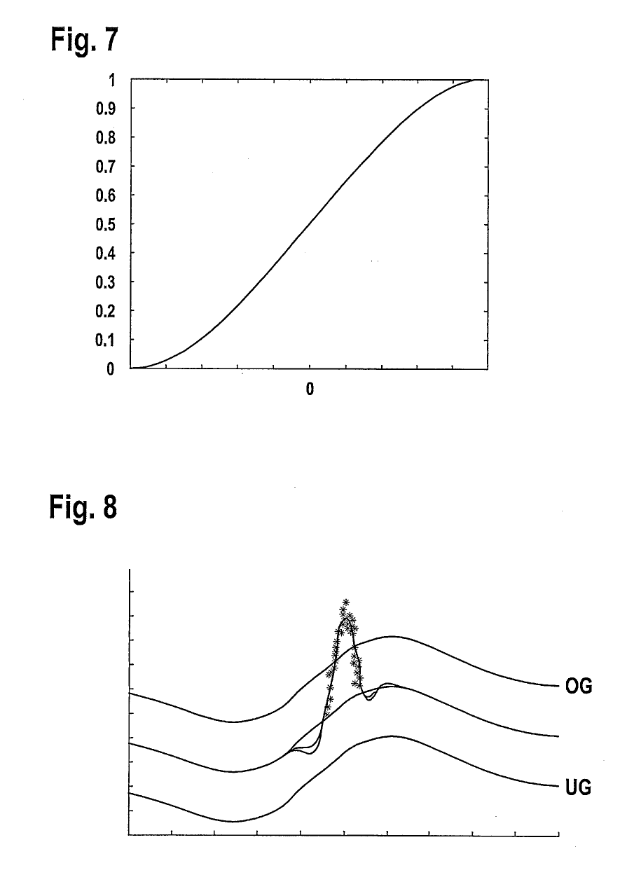

FIG. 7 shows the curve of the smoothstep function, which may be used analogously to the Fermi function. This means that, prior to applying the function values of the additive fault model to the data-based basis function model, these values are multiplied with the function value predefined by the smoothstep function and only then are they added to the function value of the data-based basis function model.

Similarly to the Fermi function, the center area of the smoothstep function essentially has a linear behavior, and thus a slope of approximately 1 results in almost no change of the function values of the additive fault model close to the area around the function curve of the data-based basis function model. A manipulation of the function values of the additive fault model only occurs close to the upper and lower limiting values OG, UG, which delimit the predefined adaption range A, so that a limitation to the upper and lower limiting values OG, UG of adaption range A takes place. In this way, it is possible to ensure a continuity of the function curve, and thus of the post-adapted function model, and consequently also good derivability.

FIG. 8 shows the curve of the function values of the data-based function model when applying the smoothstep function of FIG. 7 to the additive fault model.

What is claimed is:

1. A method for post-adaption of an at least partially data-based function model which corresponds to a sum of a data-based basis function model and an additive fault model, comprising:
providing the data-based basis function model;
recording training data;
ascertaining the additive fault model based on difference training data which represent differences between measured values of the training data and the function values of the data-based basis function model at measuring points of the training data; and
modifying at least one of the training data and the additive fault model so that function values of the data-based basis function model remain within a predefined adaption range.

2. The method as recited in claim 1, wherein the measured values of the training data are modified by limitation to one of a predefined upper limiting value or a predefined lower limiting value.

3. The method as recited in claim 2, wherein the one of the predefined upper limiting value or the predefined lower limiting value depends on the measuring point assigned to the corresponding measured value, the measuring point being dependent on a predefined limiting model.

4. The method as recited in claim 2, wherein a limiting function is applied to the additive fault model before the additive fault model is added to the data-based basis function model.

5. The method as recited in claim 4, wherein the application of the limiting function causes the maximal function value of the additive fault model and the minimal function value of the additive fault model to form the upper and lower limiting values of the adaption range.

6. The method as recited in claim 4, wherein the limiting function corresponds to one of a Fermi function, a smoothstep function or a smootherstep function.

7. The method as recited in claim 4, wherein the limiting function corresponds to a linear function having a slope of 1 within an adaption exclusion range situated within the adaption range.

8. The method as recited in claim 4, wherein the basis function model is at least partially designed as a Gaussian process model which is defined by predefined hyperparameters and node data.

9. An arithmetic unit configured for post-adaption of an at least partially data-based function model which corresponds to a sum of a data-based basis function model and an additive fault model, comprising:
means for providing the data-based basis function model;
means for recording training data;
means for ascertaining the additive fault model based on difference training data which represent differences between measured values of the training data and the function values of the data-based basis function model at measuring points of the training data; and
means for modifying at least one of the training data and the additive fault model so that function values of the data-based basis function model remain within a predefined adaption range.

10. A non-transitory computer-readable data storage medium storing a computer program having program codes which, when executed on a computer, performs a method for post-adaption of an at least partially data-based function model which corresponds to a sum of a data-based basis function model and an additive fault model, the method comprising:
providing the data-based basis function model;
recording training data;
ascertaining the additive fault model based on difference training data which represent differences between measured values of the training data and the function values of the data-based basis function model at measuring points of the training data; and
modifying at least one of the training data and the additive fault model so that function values of the data-based basis function model remain within a predefined adaption range.
